(19) United States
(12) Patent Application Publication
(10) Pub. No.: US 2016/0304324 A1
(43) Pub. Date: Oct. 20, 2016

(54) PASSIVELY ACTUATED GRAPPLING HOOK

(71) Applicants: Christopher Pagano, Glendale, NY (US); Vladislav Kopman, New York, NY (US)

(72) Inventors: Christopher Pagano, Glendale, NY (US); Vladislav Kopman, New York, NY (US)

(21) Appl. No.: 14/691,128

(22) Filed: Apr. 20, 2015

(51) Int. Cl. B66C 1/10; A62B 1/04

(52) U.S. Cl. CPC B66C 1/10; A62B 1/04

(57) ABSTRACT

A grappling hook that includes at least one central shaft, an outer collar, with the central shaft slidably mounted in the outer collar, at least one prong pivotably mounted at a distal end of the outer collar and movable between an open position in which a distal end of the at least one prong is spaced from the outer collar and a closed position in which the distal end of the at least one prong is positioned adjacent to the outer collar, a linkage mounted at a distal end of the central shaft, the linkage including at least one linkage element connected to the distal end of the at least one prong and a biasing element provided at the distal end of the central shaft and positioned between the linkage and the distal end of the outer collar such that the linkage is biased toward a position spaced away from the distal end of the outer collar and such that the linkage element holds the at least one prong in the open position.

### BACKGROUND

1. Field of the Disclosure

The present invention relates to a grappling hook including arms, or prongs, that are movable between an open position and a closed position based on a force applied by a tether element. The grappling hook preferably includes a locking mechanism to lock the arms, or prongs, in specific positions between the open and closed positions. A secondary locking mechanism may be introduced to allow for release of a captured load.

2. Related Art

Various grappling hooks have been known for some time. In some examples, the arms of the grappling hook are stationary. That is, the arms are stationary such that the ends of the arms are spaced away from the central axis of the grappling hook. Such grappling hooks are awkward to handle and difficult to store. Grappling hooks with movable arms typically require additional tether elements or other actuators and sometimes power sources to control the movement of the arms, which adds cost and complexity.

Accordingly, it would be desirable to provide a grappling hook that avoids these and other problems.

### SUMMARY

It is an object of the present invention to provide a grappling hook with arms, or prongs, that are movable between an open position in which the ends of the arms are spaced away from a central axis of the grappling hook and a closed position in which the arms are positioned adjacent to the central axis of the grappling hook, where the arms are movable from the open position to the closed position based on a force applied via a single tether element, such as a rope, cable, wire, chain, or any other suitable tether element, connected to a central shaft of the grappling hook.

A grappling hook in accordance with an embodiment of the present application includes a central shaft or shaft assembly, an outer collar, with the central shaft slidably mounted in the outer collar, at least one prong pivotably mounted at a distal end of the outer collar and movable between an open position in which a distal end of the at least one prong is spaced from the outer collar and a closed position in which the distal end of the at least one prong is positioned adjacent to the outer collar, a linkage mounted at a distal end of the central shaft, the linkage including at least one linkage element connected to the at least one prong and a biasing element positioned between the linkage and a distal end of the outer collar such that the linkage is biased toward a position spaced away from the distal end of the outer collar such that the linkage element holds the at least one prong in the open position.

A grappling hook in accordance with an embodiment of the present application includes a central shaft, an outer collar, with the central shaft slidably mounted in the outer collar, at least one prong pivotably mounted at a distal end of the outer collar and movable between an open position in which a distal end of the at least one prong is spaced from the outer collar and a closed position in which the distal end of the at least one prong is positioned adjacent to the outer collar and a linkage mounted at a distal end of the central shaft, the linkage including at least one linkage element connected to the at least one prong such that movement of the central shaft relative to the outer collar moves the at least one prong between the open position and the closed position.

A grappling hook in accordance with an embodiment of the present application includes a central shaft, an outer collar, with the central shaft slidably mounted in the outer collar and at least one prong pivotably mounted at a distal end of the outer collar and movable between an open position in which a distal end of the at least one prong is spaced from the outer collar and a closed position in which the distal end of the at least one prong is positioned adjacent to the outer collar, where the central shaft is connected to the at least one prong such that movement of the central shaft relative to the outer collar moves the at least one prong between the open position and the closed position.

Other features and advantages of the present invention will become apparent from the following description of the invention which refers to the accompanying drawings.

### BRIEF DESCRIPTION OF THE DRAWINGS

FIG. 1 illustrates an isometric view of a grappling hook in accordance with an embodiment of the present application illustrating the arms, or prongs, thereof in an open position.

FIG. 2 illustrates a grappling hook in accordance with an embodiment of the present application illustrating the arms, or prongs, thereof in an open position.

FIG. 3 illustrates the grappling hook of FIG. 1 with the arms, or prongs, thereof in a closed position.

FIG. 4 illustrates a bottom view of the grappling hook of FIG. 1.

FIG. 5A illustrates an exemplary sensor provided on the grappling hook of FIG. 1 which is in an open position with the sensor in an unactivated state.

FIG. 5B illustrates the exemplary sensor of FIG. 5A in an activated state with the grappling hook of FIG. 1 in a closed position.

FIG. 6 is a side view of the grappling hook of FIG. 1.

FIG. 7A is a detailed cross-sectional view of the grappling hook of FIG. 6 along the line A-A in FIG. 6 at a first time increment.

FIG. 7B is a detailed cross-sectional view of the grappling hook of FIG. 6 along the line A-A at a second time increment, after the first time increment.

FIG. 7C is a detailed cross-sectional view of the grappling hook of FIG. 6 along the line A-A at a third time increment, after the second time increment.

FIG. 7D is a detailed cross-sectional view of the grappling hook of FIG. 6 along the line A-A at a fourth time increment, after the third time increment.

FIG. 7E is a detailed cross-sectional view of the grappling hook of FIG. 6 along the line A-A at a fifth time increment, after the fourth time increment.

FIG. 8A illustrates an exemplary release mechanism for the locking mechanism of FIGS. 7A-E in a locked position.

FIG. 8B illustrates the exemplary release mechanism of FIG. 8A for the locking mechanism of FIGS. 7A-E in an unlocked position.

FIG. 9A illustrates a cross-sectional view of a grappling hook in accordance with an embodiment of the present application illustrating a locking mechanism in a locked position.

FIG. 9B illustrates the cross-sectional view of the grappling hook of FIG. 9A illustrating the locking mechanism in an unlocked position.

FIG. 10A illustrates a detailed cross-sectional view of a grappling hook in accordance with an embodiment of the present application illustrating a locking mechanism in a locked position.

FIG. 10B illustrates the locking mechanism of FIG. 10A in an unlocked position.

FIG. 11 illustrates a grappling hook in accordance with an embodiment of the present application that includes a second locking mechanism permitting release of a load from the grappling hook.

FIG. 12A is a detailed cross sectional view of the grappling hook of FIG. 11 along line A-A in a set open position ready for capturing a load.

FIG. 12B is a detailed cross-sectional view of the grappling hook of FIG. 11 along line A-A in a closed position.

FIG. 12C is a detailed cross-sectional view of the grappling hook of FIG. 11 along line A-A with the second locking mechanism in a releasing position.

FIG. 12D is a detailed cross-sectional view of the grappling hook of FIG. 11 along line A-A with the second locking mechanism in a fully released position.

FIG. 12E is a detailed cross-sectional view of the grappling hook of FIG. 11 along line A-A at in a fully open position.

FIG. 13A is a detailed cross-sectional view of the grappling hook of FIG. 11 along line A-A with an actuator connected to the second locking mechanism with the second locking mechanism in a locked position.

FIG. 13B is a detailed cross-sectional view of the grappling hook of FIG. 11 along line A-A with the actuator connected to the second locking mechanism with the second locking mechanism in a released position.

### DETAILED DESCRIPTION OF THE EMBODIMENTS

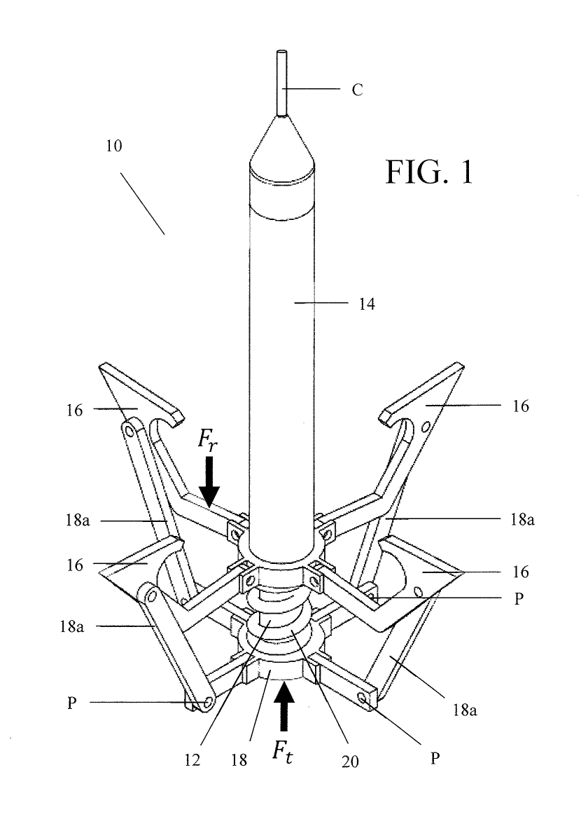

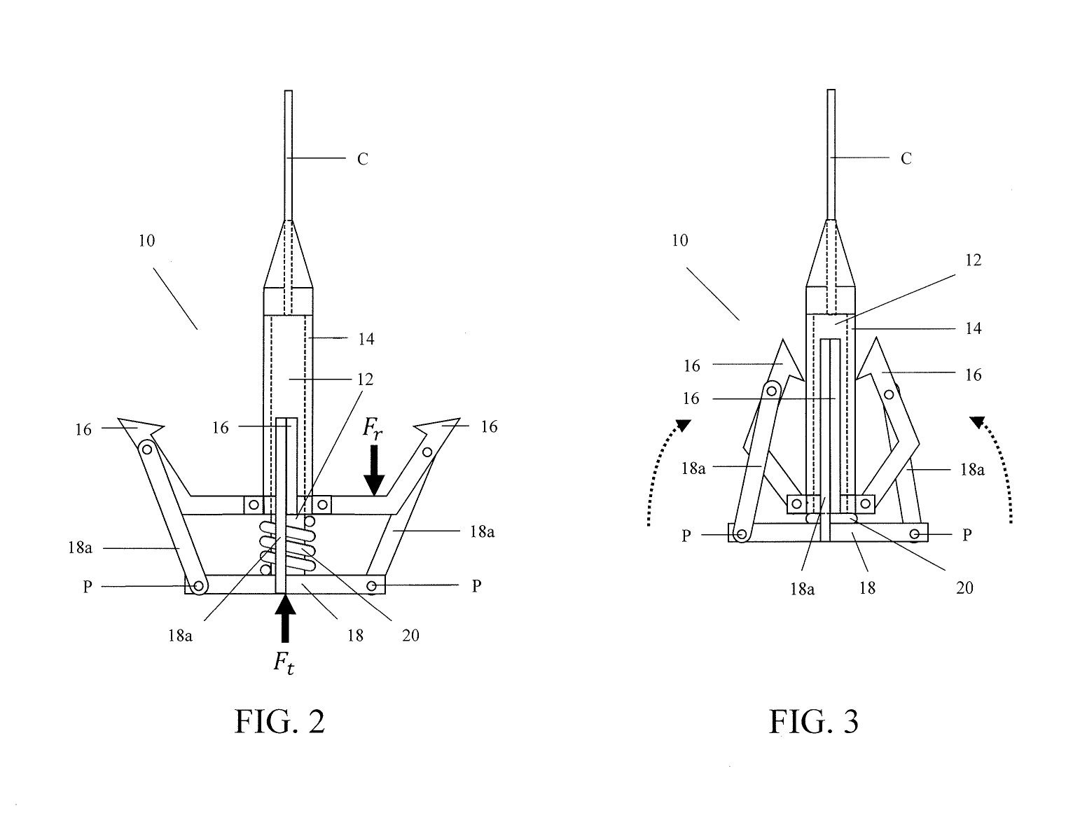

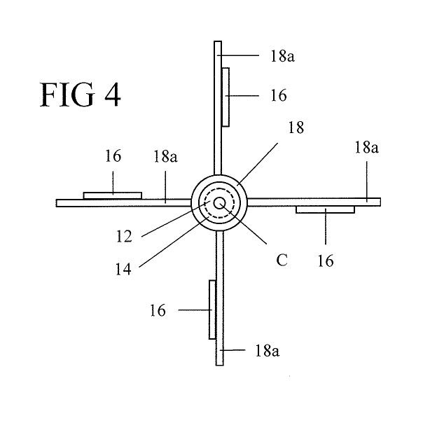

A grappling hook 10 in accordance with an embodiment of the present application is illustrated in FIGS. 1-4, for example. The grappling hook 10 preferably includes a central shaft 12 that is slidably mounted relative to an outer collar 14. In a preferred embodiment, a single tethering element in the form of cable C is connected to a proximal end of the central shaft 12 and extends away from the grappling hook 10. As can be seen in FIGS. 1-3, for example, the distal end of the central shaft 12 preferably extends beyond a distal end of the outer collar 14. The central shaft 12 may be a single shaft or a shaft assembly including multiple elements. A plurality of prongs, or arms, 16 are pivotally mounted to a distal end of the outer collar 14 and pivot between the open position of FIG. 2 and the closed position illustrated in FIG. 3. While four prongs 16 are illustrated in FIGS. 1-4, the grappling hook 10 may include additional prongs, or fewer prongs, as desired. The grappling hook 10 may include only a single prong 16, if desired. The shape of the prongs 16, may also be modified, if desired.

A linkage 18 is mounted on the distal end of the central shaft 12. The linkage 18 may include a plurality of linkage elements 18a, pivotable at point P, each of which is connected to the distal end of a respective one of the prongs 16. That is, a distal end of each linkage element 18a may be attached to a distal end of one of the prongs 16. While attachment to the distal end of the prong 16 is preferred, the present disclosure is not limited to this embodiment provided that the linkage elements 18a are connected to the prongs 16. A biasing element 20 is provided at the distal end of the central shaft 12 and positioned between the linkage 18 and the distal end of the outer collar 14 to bias the linkage 18 into a position spaced apart from the distal end of the outer collar 14 such that the prongs 16 are held in the open position as can be seen in FIG. 1 or 2, for example. In an embodiment, each linkage element 18a is pivotally connected to linkage collar 18 at P and pivotally connected to the distal end of a prong 16. The linkage element 18a, however, may use any suitable configuration.

When the flexible cable C is under tension, that is, when the grappling hook 10 experiences an applied load as indicated in FIGS. 1-2, which show the forces acting on the hook 10 and the motion due to these forces, the linkage 18 is pulled toward the collar 14 with the central shaft 12. The prongs 16 are moved closer to the collar 14 toward the closed position by the linkage elements 18a as illustrated in FIG. 3, for example. The tension force on the cable C is designated Fₜ and moves the central shaft 12 toward the cable. The resistive force Fᵣ is that of a load, the object (not shown) engaged by the grappling hook 10, pulling in the opposite direction. In this manner, the prongs 16 may be moved between the open and closed positions without the need for additional actuators, control electronics or power sources.

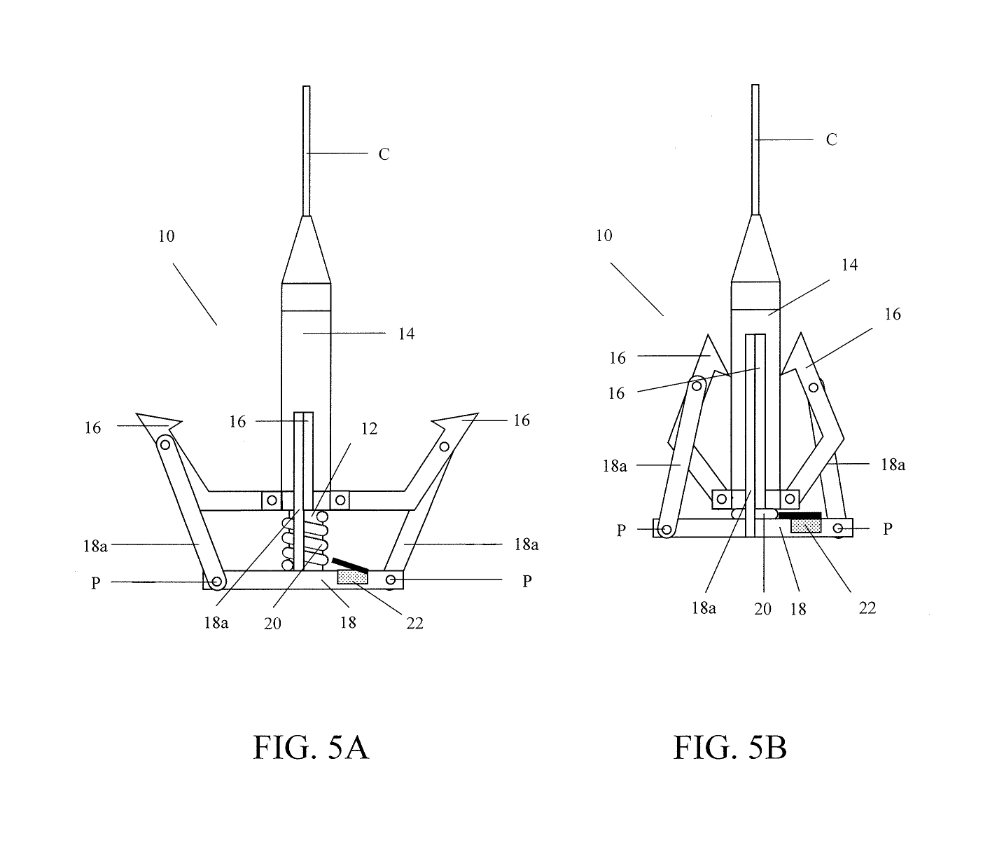

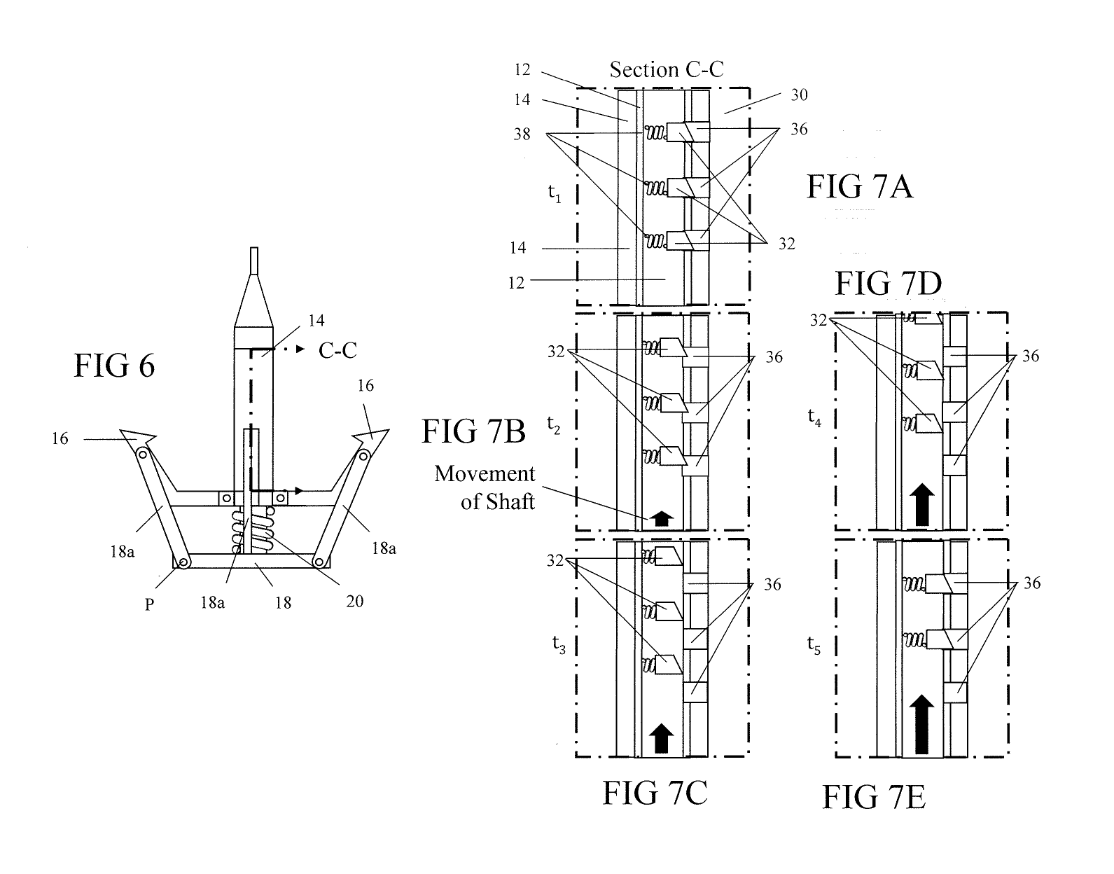

In an embodiment, a sensor 22 may be provided to indicate when the prongs 16 move into the closed position. In FIGS. 5A-5B, an exemplary embodiment of the sensor 22 is illustrated as a contact switch provided on the linkage 18. While the sensor 22 is illustrated as a contact switch, any suitable sensor may be used. When the prongs 16 of the hook 10 move into the closed position, the switch 22 is closed due to the contact between the collar 14 and the switch 22. This may be an indication that the grappling hook 10 has engaged or connected to an object, since a failed connection results in no resistive force, Fr, without which, the prongs 16 remain in the open position due to the biasing element 20. An indicator signal may also be transmitted when the prongs 16 are closed, as indicated by the sensor 22. That is, the closing of the prongs 16 due to tension on the cable C serves as an indicator that the desired connection has been made between the grappling hook 10 and a desired object. The indicator signal may be visible, audible or may be transmitted via a wired or wireless communication system to the user.

In an embodiment, a locking mechanism 30 may be provided to lock the prongs 16 into certain positions between the open position and the closed position. The locking mechanism 30 is illustrated in the cross-sectional view of FIG. 7A, for example. As illustrated, the locking mechanism 30 may be positioned in the central shaft 12 and preferably includes a plurality of lock elements 32 arranged in the central shaft for selective engagement with notches 36 formed in the outer collar 14. The lock elements 32 are biased toward the outer collar 14 via a lock biasing element 38. The lock biasing element 38 may be a simple spring, if desired, however, any suitable biasing member may be used. The distal end of each lock element 32, which faces the collar 14, is preferably angled such that movement of the central shaft 12 in the direction of the cable C is permitted when the lock elements 32 are positioned in the notches 36, but the central shaft 12 is prevented from sliding in the opposite direction.

Operation of the locking mechanism 30 is described with reference to FIGS. 7A-7E. In FIG. 7A at time interval t1, the lock elements 32 are positioned in the notches 36 and prevent movement of the shaft 12 in a direction away from the cable C. At time interval t2 in FIG. 7B, the central shaft 12 is sliding toward the cable C as a tension force is applied. The angled distal ends of the lock elements 32 allow this movement. As the shaft 12 slides, the angled distal ends of the lock elements interact with the walls of the notches 36 to push the lock elements back against the lock biasing element 38. At time interval t3 illustrated in FIG. 7C, the lock elements 32 have been pushed back completely out of the notches 36 and the central shaft 12 continues to slide toward the cable C. At this time, if the tension force on the cable C is released, the shaft 12 will slide in the opposite direction based on the force applied by the biasing element 20. This sliding will stop, however, when the lock elements 32 re-enter the notches 36. At time interval t4 in FIG. 7D, the lock elements 32 are fully retracted and are approaching different notches 36. At time interval t5 in FIG. 7E, the lock elements 32 are engaged in the notches 36, however, each respective lock element 32 is engaged in a different notch than in FIG. 7A. While the lock elements 32 are position in the notches 36, they prevent the central shaft 12 from sliding in a direction opposite the cable C at all, even if the tension force on the cable C is removed. Thus, the prongs 16 may be locked at distinct positions between the open position and the closed position, if desired. In an embodiment, an actuator may be provided in a releasing mechanism to release the locking mechanism 30.

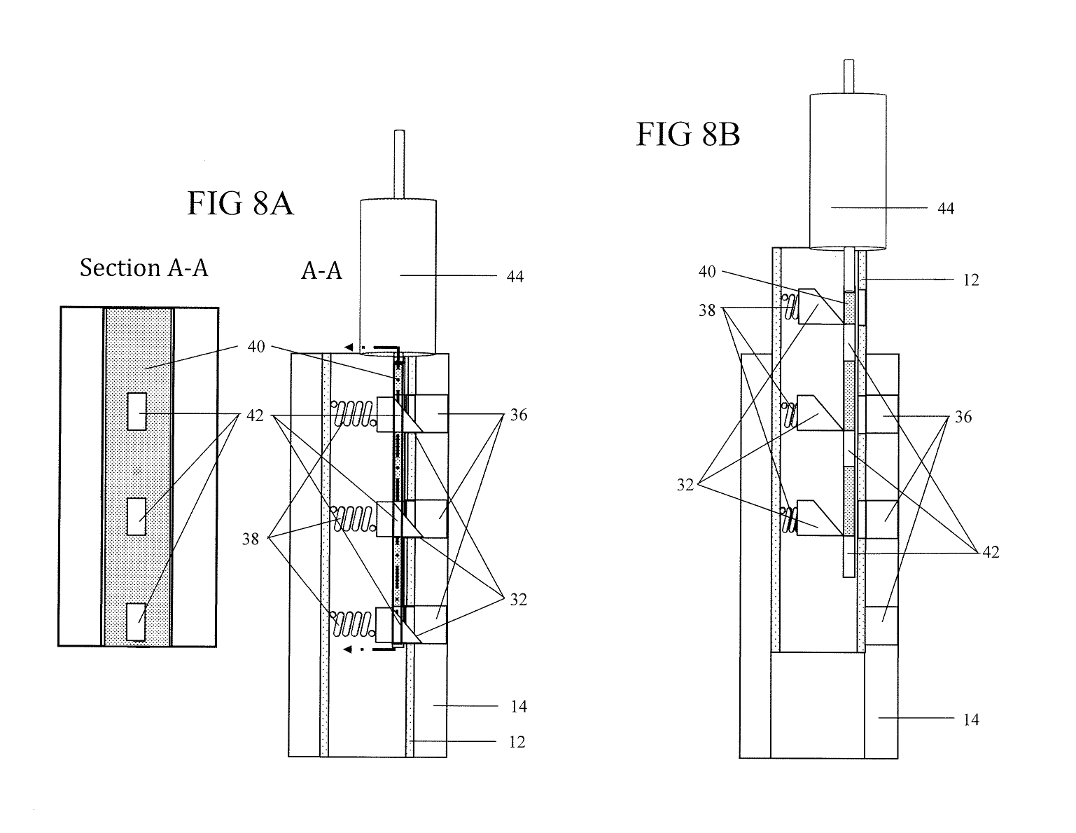

FIGS. 8A-8B show an exemplary embodiment of a releasing mechanism 44 for releasing the locking mechanism 30. The releasing mechanism 44 is specifically illustrated as a linear actuator, where the linear actuator pushes a plate 40 residing within a hollow portion of the inner shaft 12, to release the lock elements 32. The plate 40 may include openings 42 that allow the lock elements 32 to protrude out of the inner shaft 12. While the linear actuator 44 is not energized, the plate 40 is in the de-energized or locked position, as depicted in FIG. 8A at Section A-A, for example. In this position, the lock elements 32 protrude out of the inner shaft 12 through the opening 42 in the plate 40 and into the notches 36 of the outer collar 14 to provide locking features as described above. To release the lock elements 32, the plate 40 is pushed downward by energizing the linear actuator 44. The angled distal ends of the lock elements 32 interact with the walls of the openings 42 in the plate 40 as it moves downward to move the lock elements against the biasing force of the lock biasing elements 38 and out of the notches 36 of the outer collar 14 and into the inner shaft 12, as can be seen in FIG. 8B. With the lock elements 32 in this position, the inner shaft 12 is free to move relative to the outer collar 14. Due to its own mass, the inner shaft 12 will slide down causing the hook 10 to open. While three lock elements 32 are illustrated in FIGS. 7A-7E and 8A-8B, fewer or more lock elements 32 may be used. In addition, fewer or more notches 36 or openings 42 may be provided in the collar 14 and plate 40. If desired, a single lock element 32 may be used with multiple notches 36. Moreover, the notches 36 may be substituted with any suitable recess or protruding incremental feature or combinations thereof.

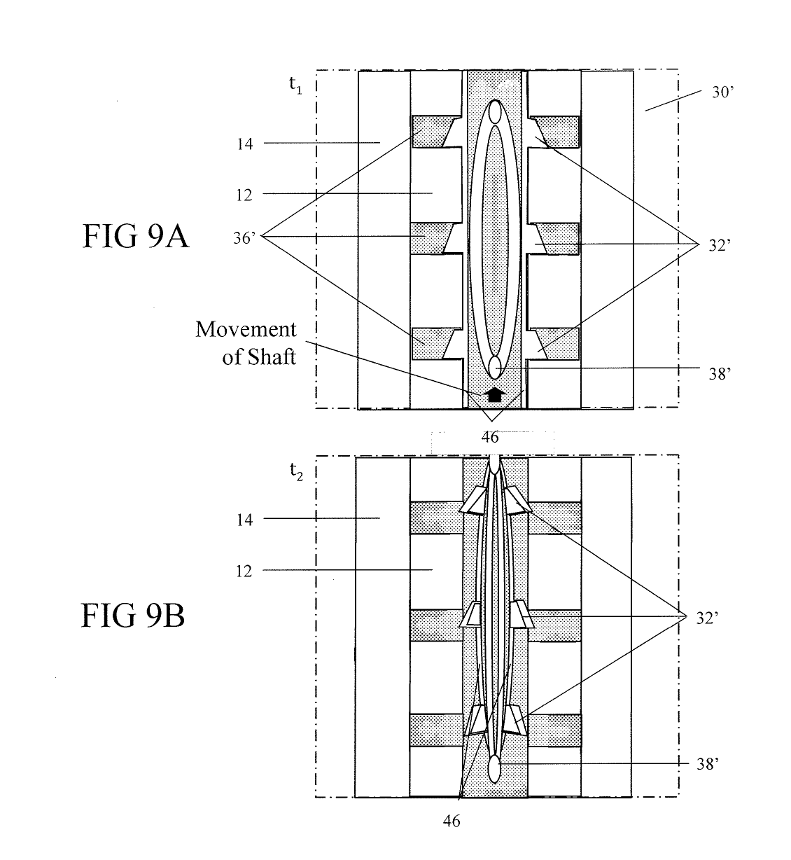

FIG. 9A illustrates an alternative embodiment of a locking mechanism 30′. In this embodiment, the central shaft 12 is hollow, or includes a hollow portion. The locking mechanism 30′ includes lock biasing element 38′. The lock elements 32′ are biased outward toward the collar 14 to engage the collar via lock biasing element 38′. In an embodiment, sets of lock elements 32′ are provided on flexible membranes 46 which are biased into a locking position, although more or fewer elements can be used. As the tension force is applied on the shaft 12 via the cable C, the shaft 12 moves upward with respect to the outer collar 14 in the direction indicated by the arrow in FIG. 9A. The sloped distal ends of the lock elements 32′ create a force component that begins to compress the lock elements 32′ while at the same time prevents the shaft from sliding in the direction opposite the applied tension force. Once the next set of notches 36′ are engaged, the lock elements 32′ snap into place due to the lock biasing element 38′. While the distal ends of the lock elements 32′ are shown sloped in this embodiment, any design that causes the lock elements to compress under a radial load may be used. The lock biasing element 38′ is preferably a leaf spring that pushes the lock elements 32′ out into the collar 14. To release the lock elements 32′ in this embodiment, an actuator may be used to pull the biasing element 38′, retracting the lock elements 32′ with tension applied to the shaft 12. Additional or fewer lock elements 32′ may be provided if desired.

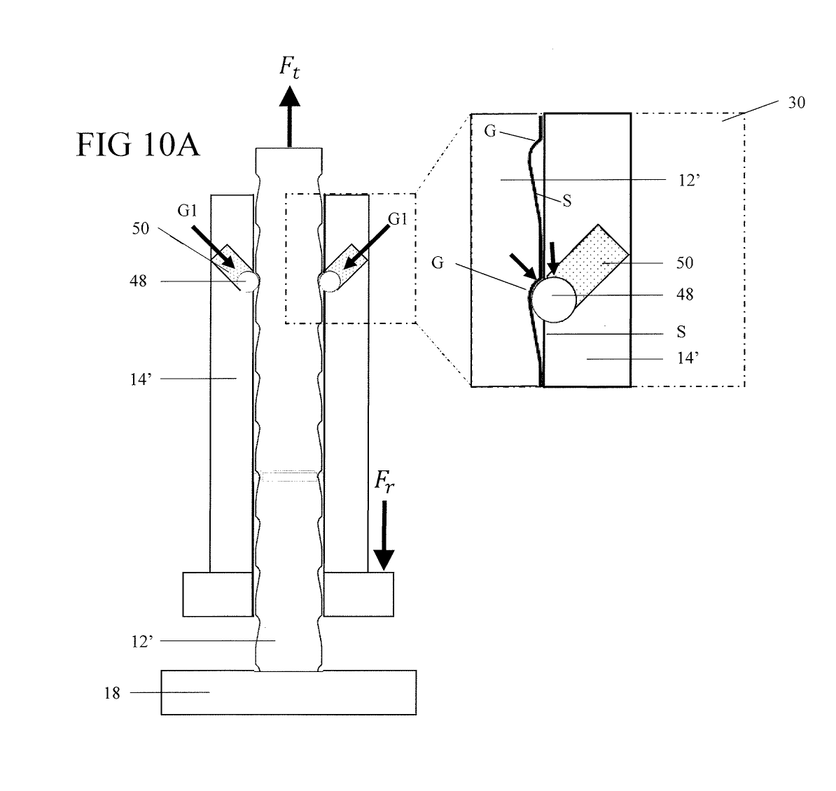

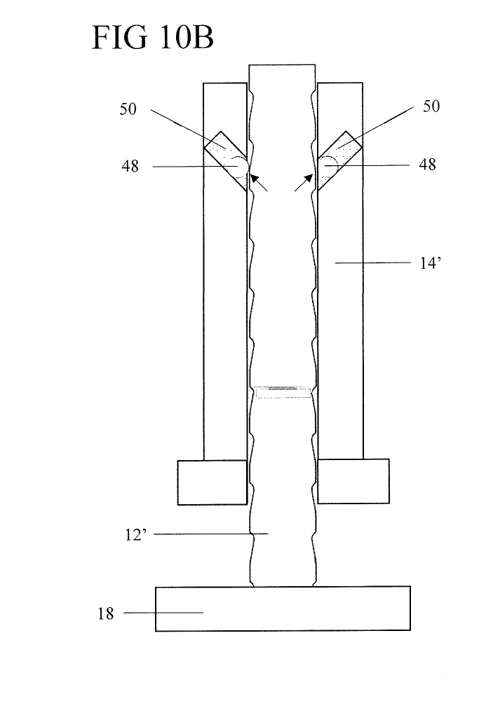

A third embodiment of the locking mechanism 30″ involves the use of a turned shaft 12′ shown in FIG. 10A, for example. The shaft 12′ has an outer surface including sloped sections S followed by deeper groove portions G sized and shaped to accommodate ball elements 48. These ball elements 48 fit inside sloped, or angled, notches 50, formed in collar 14′. The notches 50 are angled such that the ball elements 48 are biased downward due to gravity as by the arrows G1 shown in FIG. 10A, for example. As the shaft 12′ is moved upward with respect to collar 14′, the ball elements 48 move upward along the sloped section S as shown in FIG. 10B. As the shaft 12′ continues to move upward the ball element 48 will fall into the next deep groove portion G. Beyond this point, even with a loss in tension, the shaft 12′ will not be able to move downward due to the lack of an upward component to push the ball element 48 up into the notch 50, unlocking its position as indicated in FIG. 10A. While the embodiment shown in FIG. 10A-B rely on gravity to bias the ball elements 48 toward the shaft 12″, a biasing element, such as a spring may be used to allow for use of the grappling hook 10 at a variety of angles. If desired, the angle of the notches 50 may be varied as well.

The grappling hook 10 includes movable prongs 16 that can be easily closed to engage items by simply applying pressure to a single tether element such as the cable C. While the present application discusses a cable C, a rope, chain, wire, rod, central shaft extension or any other suitable tether element may be used to apply the tension force to the central shaft 12 and move the prongs 16 from the open position to the closed position. In an embodiment, the tether element may be a rigid element such as a rod, shaft or pole. One example of such a rigid element is a tailhook extending from an aircraft.

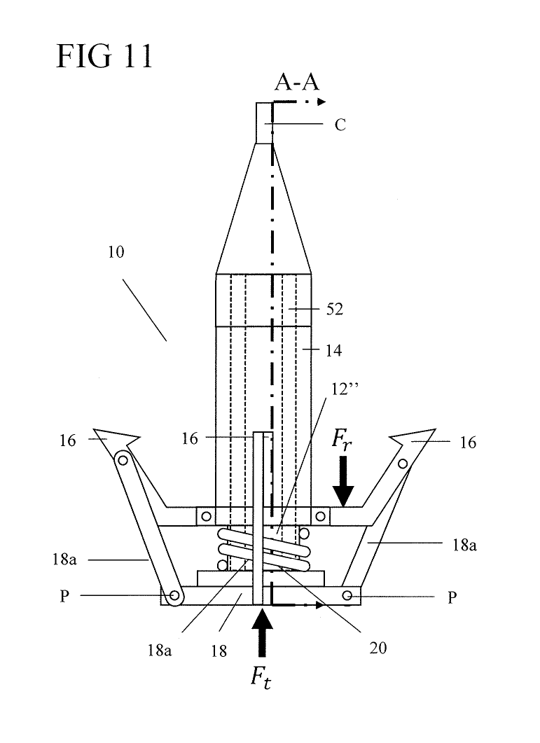

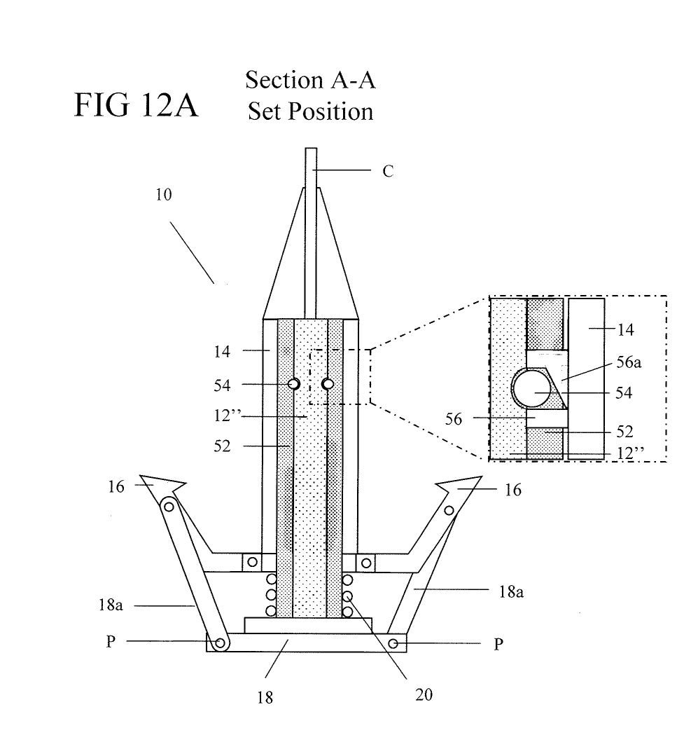

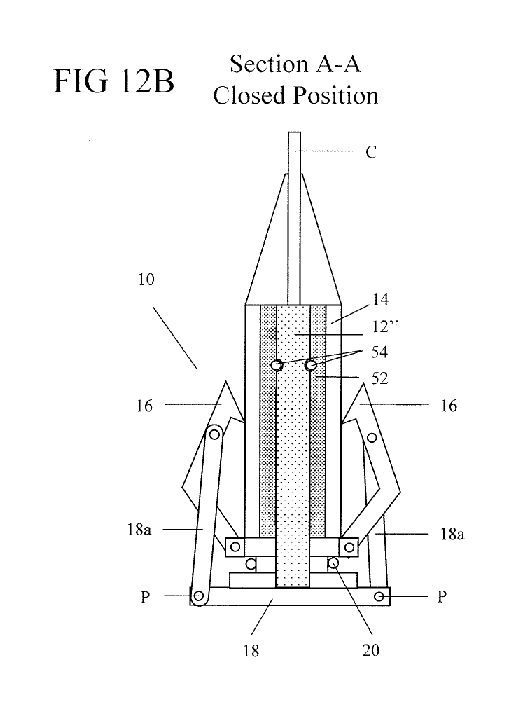

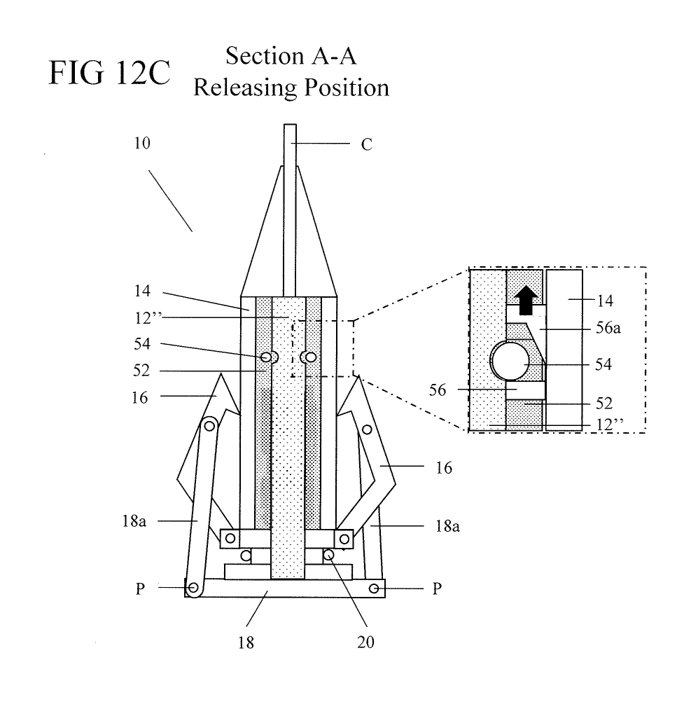

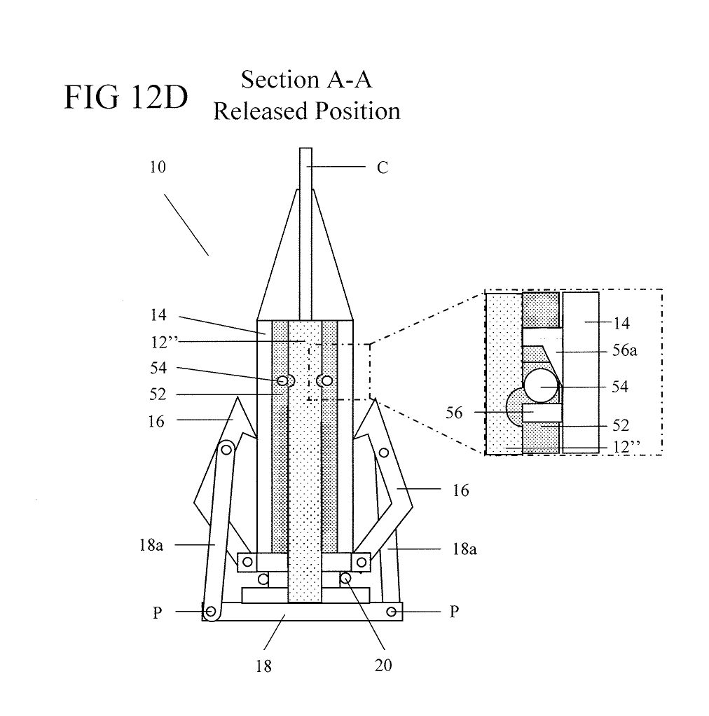

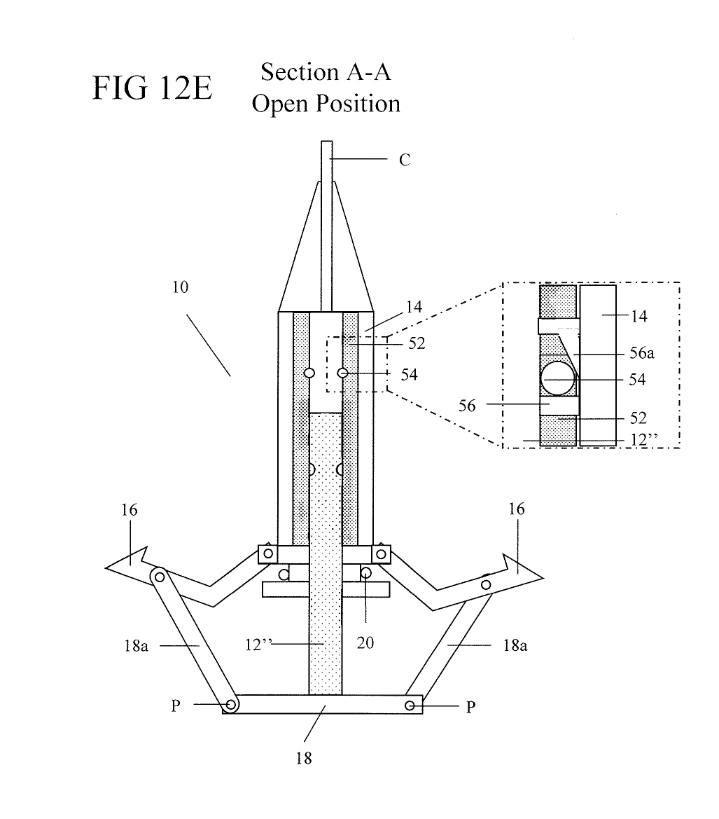

In another embodiment, a third element is provided between the shaft 12″ and collar 14″ in order to allow the grappling hook 10 to release its payload even when the tension force Fr of the load is applied, as shown in FIG. 11. In the embodiments discussed above, the opening of the hook 10, that is, the movement of the prongs 16 from the closed to open position, is possible only when the load is not applied to the prong. To overcome this limitation, a third shaft 52 may be initially coupled to the central shaft 12″ via locking elements 54, for example as shown in FIG. 12A. This coupling may be achieved using locking elements 54 that are restricted by an outer collar 56, more specifically, the wedge portion 56a thereof. The grappling hook 10 closes in a manner similar to that described above except that the shaft 12″ is initially bonded to the third shaft 52 via locking elements 54 and the shaft 52 moves with the shaft 12″. In this embodiment, to release a load, the locking elements 54 on the middle shaft 52 are released by lifting the wedge portion 56a of the collar 56. This allows the locking elements 54, which have a spherical shape, to move radially outward, allowing the shaft 12″ to fall due to its own weight and the load Fr applied on the prongs 16. While locking elements 54 having a spherical shape are shown in this embodiment, any other suitable locking elements may be used.

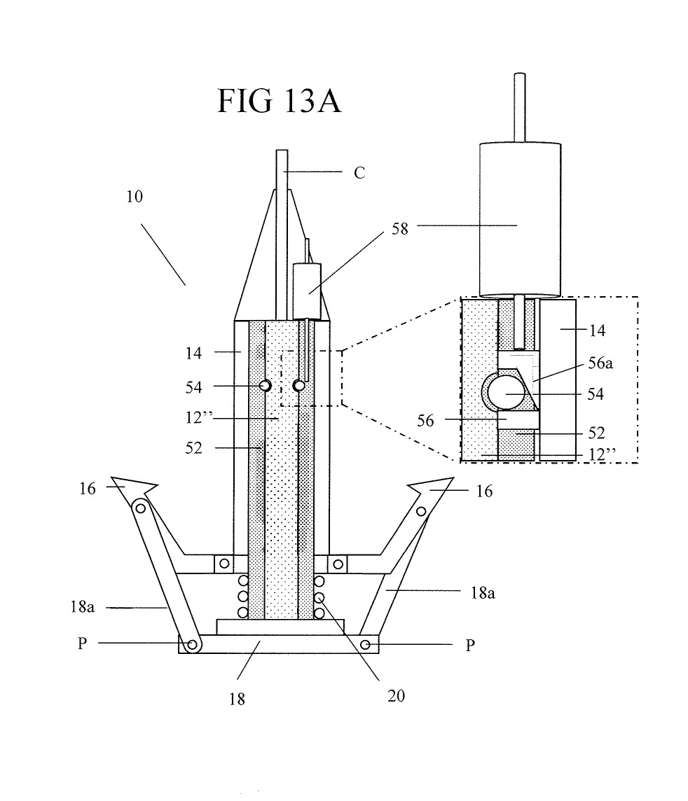

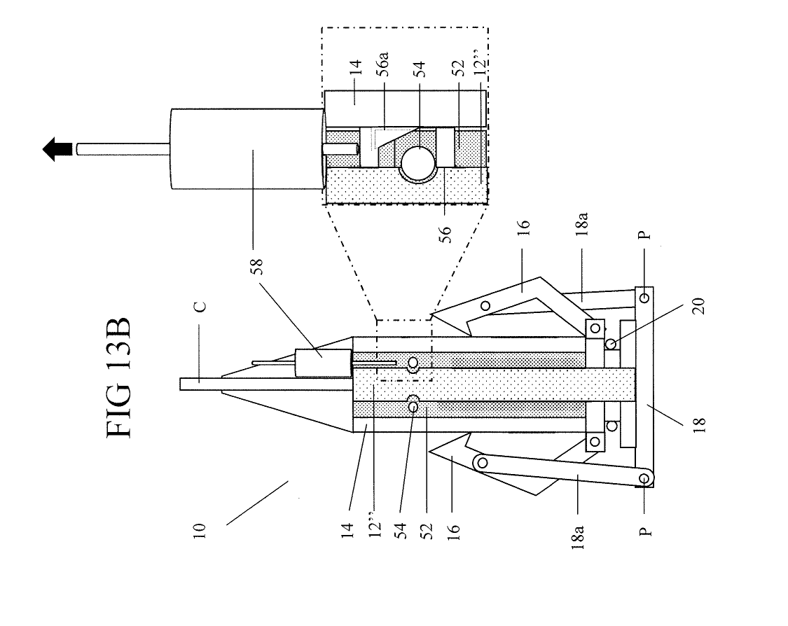

FIG. 12A illustrates the set open position for the grappling hook 10 to capture a load. The middle shaft 52 and central shaft 12″ are coupled via collar 56 and the locking elements 54, which are positioned in a groove of the inner shaft 12″. As a load is applied to a prong 16, the coupled shafts, 12″ and 52, move upward. Although this embodiment depicts a single collar 56, more collars may be used, but are not required. Once fully closed, the grappling hook 10 resembles FIG. 12B. When the load is ready to be released, the wedge portion 56a of the collar 56 may be lifted via an actuator or secondary cable pulled by an external actuator, for example, which allows the locking elements 54 to move outward, following the surface of the shaft as shown in FIG. 12C-D. An exemplary actuator is shown in FIGS. 13A-13B, which is specifically illustrated as linear actuator 58. The linear actuator 58 may be used to pull the wedge portion 56a upward to release the locking elements 54. Once the coupling is broken, the central shaft 12″ is free to move downward due to its weight and the load applied to the prongs 16. As illustrated in FIG. 12E, due to the motion of the central shaft 12″, the prongs 16 are allowed to open, that is, move into the open position, due to the linkage 18, and may extend beyond the initial open position in FIG. 12A. Once the load is released, the biasing element 20 returns the prongs 16 to the open position of FIG. 12A at which point the wedge portion 56a is released, or returned to position by actuator 58 for re-coupling the two shafts 12″ and 52.

Although the present invention has been described in relation to particular embodiments thereof, many other variations and modifications and other uses will become apparent to those skilled in the art.

What is claimed is:

1. A grappling hook comprises:
a central shaft;
an outer collar, with the central shaft slidably mounted in the outer collar;
at least one prong pivotably mounted at a distal end of the outer collar and movable between an open position in which a distal end of the at least one prong is spaced from the outer collar and a closed position in which the distal end of the at least one prong is positioned adjacent to the outer collar;
a linkage mounted at a distal end of the central shaft, the linkage including at least one linkage element connected to the at least one prong; and
a biasing element provided at the distal end of the central shaft and positioned between the linkage and the distal end of the outer collar such that the linkage is biased toward a position spaced away from the distal end of the outer collar such that the linkage element holds the at least one prong in the open position.

2. The grappling hook of claim 1, further comprising a tether element attached to the central shaft, wherein the central shaft slides in the direction of the tether element when a tension force is applied to the tether element.

3. The grappling hook of claim 2, wherein the tether element is a flexible cable.

4. The grappling hook of claim 2, wherein the tether element is a rope.

5. The grappling hook of claim 2, wherein the tether element is a chain.

6. The grappling hook of claim 2, wherein the tether element is a rigid element.

7. The grappling hook of claim 2, wherein the linkage moves toward the distal end of the outer collar when the central shaft slides in the direction of the tether element such that the linkage element moves the at least one prong toward the closed position.

8. The grappling hook of claim 7, further comprising a locking mechanism mounted in the central shaft, the locking mechanism operable to lock the at least one prong in at least one position between the open position and the closed position.

9. The grappling hook of claim 8, wherein the locking mechanism limits sliding of the central shaft in a direction opposite that of the tether element even when no tension force is applied to the tether element.

10. The grappling hook of claim 1, further comprising a sensor configured to detect when the at least one prong is in the closed position.

11. The grappling hook of claim 10, wherein the sensor provides an indicator signal to a user when the at least one prong is in the closed position.

12. The grappling hook of claim 7, further comprising a plurality of prongs, wherein each prong of the plurality of prongs is mounted on the distal end of the outer collar and is movable between the open position and the closed position.

13. The grappling hook of claim 12, wherein the linkage further comprises a plurality of linkage elements and each linkage element of the plurality of linkage elements is connected to a respective distal end of one of the prongs of the plurality of prongs.

14. The grappling hook of claim 1, wherein biasing element is a coil spring wrapped around the distal end of the central shaft.

15. The grappling hook of claim 1, wherein the central shaft is longer than the outer collar such that the distal end of the central shaft extends beyond the distal end of the outer collar.

16. The grappling hook of claim 15, wherein the biasing element is provided on the distal end of the central shaft on a portion of the central shaft extending beyond the inner collar.

17. The grappling hook of claim 1, further comprising a second shaft coupled to the central shaft via a locking mechanism.

18. The grappling hook of claim 16, further comprising an actuator operably connected to the locking mechanism and configured to release the locking mechanism such that the central shaft is slidable relative to the second shaft even when a load is applied to at least one prong to allow the prongs to return to the open position.

19. A grappling hook comprises:
a central shaft;
an outer collar, with the central shaft slidably mounted in the outer collar;
at least one prong pivotably mounted at a distal end of the outer collar and movable between an open position in which a distal end of the at least one prong is spaced from the outer collar and a closed position in which the distal end of the at least one prong is positioned adjacent to the outer collar; and
a linkage mounted at a distal end of the central shaft, the linkage including at least one linkage element connected to the at least one prong such that movement of the central shaft relative to the outer collar moves the at least one prong between the open position and the closed position.

20. A grappling hook comprises:
a central shaft;
an outer collar, with the central shaft slidably mounted in the outer collar; and
at least one prong pivotably mounted at a distal end of the outer collar and movable between an open position in which a distal end of the at least one prong is spaced from the outer collar and a closed position in which the distal end of the at least one prong is positioned adjacent to the outer collar, where the central shaft is connected to the at least one prong such that movement of the central shaft relative to the outer collar moves the at least one prong between the open position and the closed position.
